(19) United States
(12) Patent Application Publication
(10) Pub. No.: US 2022/0141654 A1
(43) Pub. Date: May 5, 2022

(54) Enhanced VoLTE PDCP Protection Using Hybrid Approach

(71) Applicant: Parallel Wireless, Inc., Nashua, NH (US)

(72) Inventors: Oren Zaharia, Rishon LeZion (IL); Ido Shaked, Alfei Menashe (IL); Pradeep Macharla, Tzur Itzhak (IL); Netanel Gabizon, Sal'lt (IL); Benjamin Abramovsky, Petah Tiqwa (IL)

(21) Appl. No.: 17/516,679

(22) Filed: Nov. 1, 2021

Related U.S. Application Data
(60) Provisional application No. 63/107,487, filed on Oct. 30, 2020.

(51) Int. Cl. H04W 12/033; H04W 80/02; H04W 12/041; H04W 28/16

(52) U.S. Cl. CPC H04W 12/033; H04W 28/16; H04W 12/041; H04W 80/02

(57) ABSTRACT

Systems, methods and computer software are disclosed for providing Voice over Long-Term Evolution (VoLTE) Packet Data Conversion Protocol (PDCP) protection. In one embodiment a method is disclosed, comprising: connecting a User Equipment (UE) Radio Resource Control (RRC); providing a VoLTE call; determining, when the VoLTE call has ended, if unused bearer values for a current key are used; and when unused bearer values for a current key are unused, allocating new bearer value for a next VoLTE call.

### CROSS-REFERENCE TO RELATED APPLICATIONS

This application claims priority under 35 U.S.C. § 119(e) to U.S. Provisional Pat. App. No. 63/107,487, filed Oct. 30, 2020, titled “Enhanced VoLTE PDCP Protection Using Hybrid Approach” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sept. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828427, U.S. Pat. App. Pub. Nos. US20170273134A1, US20170127409A1 in their entirety. This document also hereby incorporates by reference 3GPP TS 33.401 v16.3.0 in its entirety.

### BACKGROUND

In Long Term Evolution (LTE), Packet Data Convergence Protocol (PDCP) encryption uses agreed key between the User Equipment (UE) and the network to encrypt the air interface. The keystream is generated by applying to Encryption Algorithm (EEA) component the following components: KEY—128 bit cipher key, COUNT—32 bit value is from PDCP COUNT, BEARER—5 bit bearer ID also known as DRB ID, DIRECTION—1 bit direction (uplink/downlink), and LENGTH—length of required keystream (packet length)—this effect only the keystream block length

PDCP encryption for Voice over LTE (VoLTE) calls contain security breach when same keystream is being used for consecutive VoLTE calls. In this disclosure we propose way to use the existing standard to mitigate this breach while offering small air interface overhead and minimal implementation complexity.

### SUMMARY

A method, system and computer readable medium are described for providing enhanced VoLTE PDCP Protection Using Hybrid Approach. In one embodiment a method providing VoLTE PDCP Protection includes: connecting UE RRC; providing a VoLTE call; determining, when the VoLTE call has ended, if unused bearer values for a current key are used; when unused bearer values for a current key are not used, performing horizontal key generation and resetting a used bearer list; and when unused bearer values for a current key are used, allocating new bearer value for a next VoLTE call.

In another example embodiment a system providing Voice over Long-Term Evolution (VoLTE) Packet Data Conversion Protocol (PDCP) protection includes an eNodeB including Radio Resource Control (RRC); wherein the eNodeB receives a VoLTE call and determines, when the VoLTE call has ended, if unused bearer values for a current key are used; and wherein when unused bearer values for a current key are unused, allocates a new bearer value for a next VoLTE call.

In another embodiment a non-transitory computer-readable medium containing instructions for providing Voice over Long-Term Evolution (VoLTE) Packet Data Conversion Protocol (PDCP) protection which, when executed, cause a system to perform steps comprising: connecting a User Equipment (UE) Radio Resource Control (RRC); providing a VoLTE call; determining, when the VoLTE call has ended, if unused bearer values for a current key are used; and when unused bearer values for a current key are unused, allocating new bearer value for a next VoLTE call.

### BRIEF DESCRIPTION OF THE DRAWINGS

FIG. 1 is a diagram showing PDCP encryption, in accordance with some embodiments.

FIG. 2 is a flow diagram for an enhanced VoLTE PDCP protection using hybrid approach, in accordance with some embodiments.

FIGS. 3A and 3B are a call flow diagram for an enhanced VoLTE PDCP protection using hybrid approach, in accordance with some embodiments.

FIG. 4 is a schematic network architecture diagram for 3G and other-G prior art networks.

FIG. 5 is an enhanced eNodeB for performing the methods described herein, in accordance with some embodiments.

FIG. 6 is a coordinating server for providing services and performing methods as described herein, in accordance with some embodiments.

### DETAILED DESCRIPTION

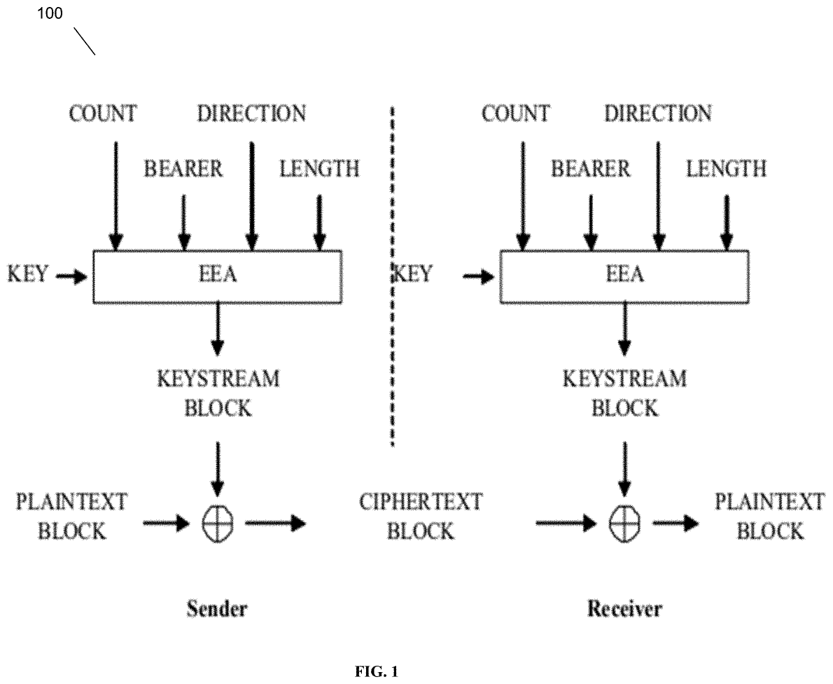

Referring to FIG. 1, in LTE, PDCP encryption 100 uses a key, count, a bearer, a direction and length components. When bearer is allocated the COUNT is reinitialized to 0. KEY can by updated by horizontal (with EnodeB) or vertical key generation (with core network). LENGTH only effect the keystream length and DIRECTION depends on the direction of the link (uplink or downlink). BEARER is assigned by the eNodeB when new bearer is allocated for the user.

By using this cryptosystem, the UE and EnodeB can encrypt their transmission over the air preventing the reception of the data by 3^{rd} party entity.

The keystream is applied to the plaintext by XOR meaning theoretically that if someone has stream of plaintext and ciphertext, the keystream block is derived easily:

keystream=plaintext XOR ciphertext

Problem

When UE is in RRC Connected state and it is taking part in back to back VoLTE calls with short time between them, the same KEY will be used as no new horizontal or vertical key generation was done between the calls.

The COUNT & DIRECTION values are known and is the same for all the calls.

LENGTH—for VOLTE calls if the link conditions remained the same it will be the same as this service has constant data rate.

When BEARER is the same and not changed between VoLTE calls, the same KEYSTREAM is used, allowing an adversary to decipher VoLTE calls using the following equipment: Air interface sniffer, Cellphone, Computer; and following these steps:

Alice calls Bob, their call is being intercepted through the air interface by Eve. <at this step the intercepted call is encrypted by EEA keystream>

After the call was ended. Eve calls Alice call duration is equal or bigger than the call duration before.<now Eve has the intercepted encrypted call using her sniffer and deciphered call as she was part of the 2^{nd} call>

Using what Eve gathered from the 2^{nd} call Eve gets the keystream values for the 2^{nd} call as was mentioned in the problem section.

Using the keystream and using the fact that the same values of parameters was used for generation of ciphertext for the two calls, Eve decodes the ciphered 1st call and hears the call Alice had with Bob.

### Solution to Problem

In order to solve this security vulnerability, the EEA can be initialized by different set of parameters every VoLTE call in order to mitigate this threat.

There are two fields which can be changed here: KEY and BEARER. KEY is regenerated by using horizontal or vertical key generation. BEARER is changed by simply applying different BEARER value to each call.

If the EnodeB will force key regeneration after each VoLTE call for sure the generated keystream block set will be unique for each call however this process requires processing time and air interface resources.

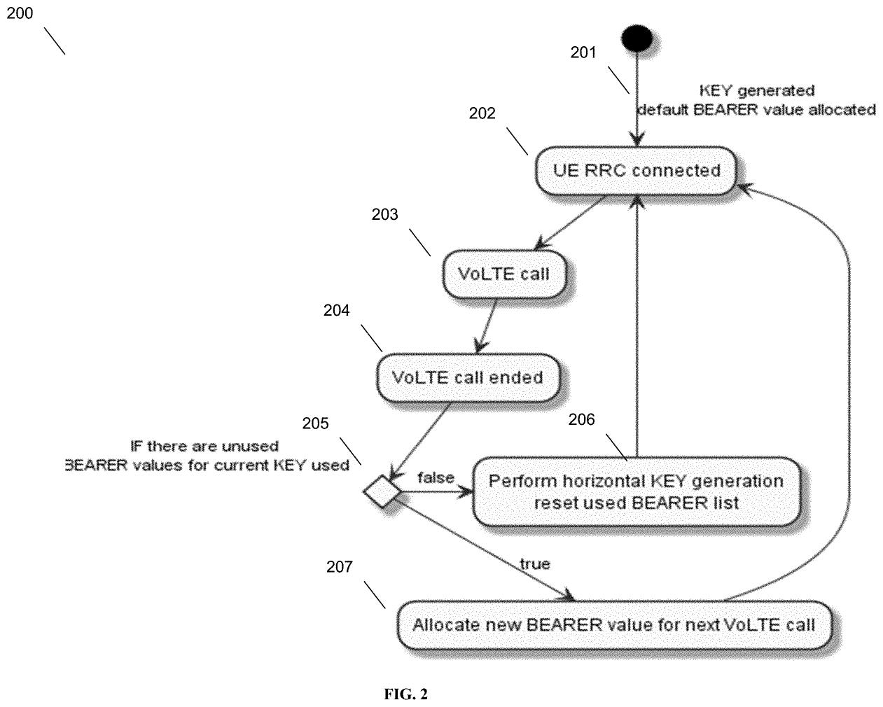

Using different BEARER value for each VoLTE call offers simpler solution will no impact for both the air interface and the processing time. This solution however is still problematic as Eve can do N VoLTE calls to Alice, as BEARER is only 5 bits wide, Eve will gather N sets of keystreams. If N>32 it is highly likely one of the derived keystreams will match the keystream used by the 1st call made by Alice and Bob allowing the deciphering of this call by Alice. It is efficient to combine these approaches as can be seen in the flow diagram 200 of FIG. 2

A flow chart of a particular embodiment of the presently disclosed method is depicted in FIG. 2. The rectangular elements denote “processing blocks” and represent computer software instructions or groups of instructions. The diamond shaped elements denote “decision blocks,” and represent computer software instructions, or groups of instructions which affect the execution of the computer software instructions represented by the processing blocks.

Alternatively, the processing and decision blocks may represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

At processing block 201 a key is generated and bearer values are allocated. At processing block 202 UE RRC is connected. As shown in processing block 203 a VoLTE call is received. In processing block 204 the VoLTE call is ended.

A determination is made at decision block 204 regarding whether there are unused bearer values for the current key. As shown in processing block 207, when VoLTE call is terminated new BEARER will be allocated for the next call. If all BEARER values were used and no horizontal or vertical KEY generation was done, the EnodeB can do horizontal KEY generation in order to prevent BEARER values wraparound as shown in processing block 206. If the user was disconnected or new KEY was generated used BEARER list will be cleared. Following this method, the simpler solution will be used most of the time and only when no other option exist horizontal KEY generation will be triggered.

Architecture Diagram

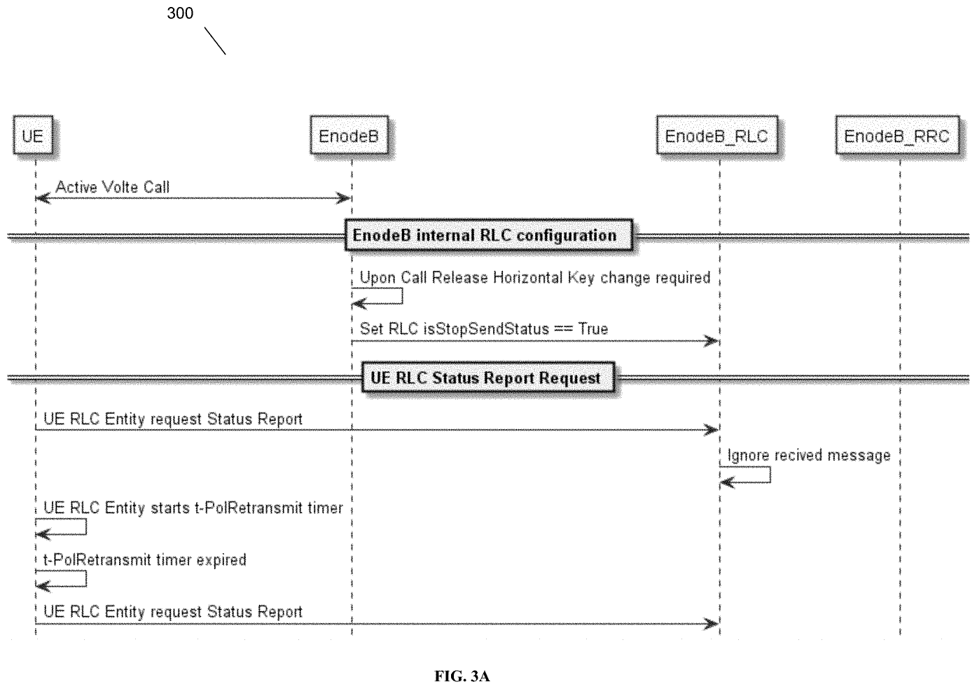

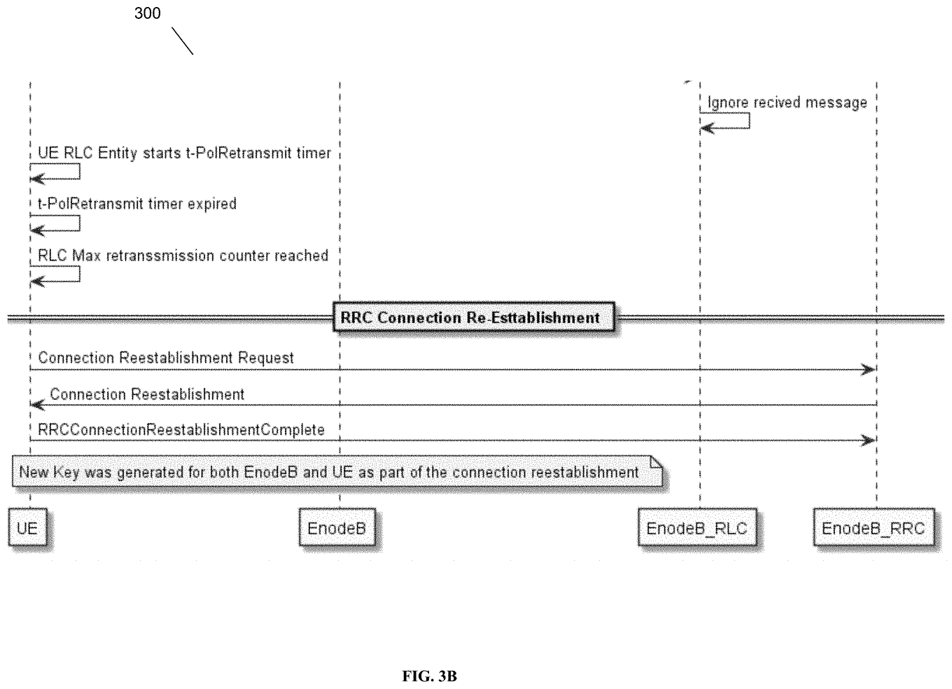

As most of the flow is previously described, in this section we would like to provide one option for triggering the key exchange by performing horizontal key generation by causing the EnodeB RLC to stop replaying to status PDU requests by the UE RLC entity. This is shown in the call flow 300 of FIG. 3.

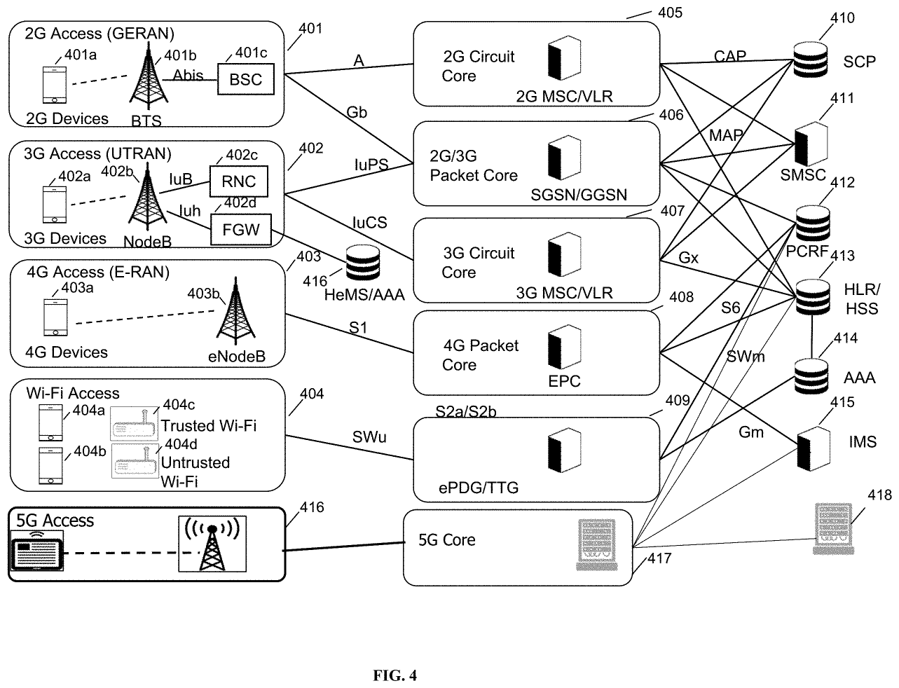

FIG. 4 is a schematic network architecture diagram for 3G and other-G prior art networks. The diagram shows a plurality of “Gs,” including 2G, 3G, 4G, 5G and Wi-Fi. 2G is represented by GERAN 401, which includes a 2G device 401a, BTS 401b, and BSC 401c. 3G is represented by UTRAN 402, which includes a 3G UE 402a, nodeB 402b, RNC 402c, and femto gateway (FGW, which in 3GPP namespace is also known as a Home nodeB Gateway or HNBGW) 402d. 4G is represented by EUTRAN or E-RAN 403, which includes an LTE UE 403a and LTE eNodeB 403b. Wi-Fi is represented by Wi-Fi access network 404, which includes a trusted Wi-Fi access point 404c and an untrusted Wi-Fi access point 404d. The Wi-Fi devices 404a and 404b access either AP 404c or 404d. In the current network architecture, each “G” has a core network. 2G circuit core network 405 includes a 2G MSC/VLR; 2G/3G packet core network 406 includes an SGSN/GGSN (for EDGE or UMTS packet traffic); 3G circuit core 407 includes a 3G MSC/VLR; 4G circuit core 408 includes an evolved packet core (EPC); and in some embodiments the Wi-Fi access network is connected via an ePDG/TTG using S2a/S2b. Each of these nodes are connected via a number of different protocols and interfaces, as shown, to other, non-“G”-specific network nodes, such as the SCP 430, the SMSC 431, PCRF 432, HLR/HSS 433, Authentication, Authorization, and Accounting server (AAA) 434, and IP Multimedia Subsystem (IMS) 435. An HeMS/AAA 436 is present in some cases for use by the 3G UTRAN. The diagram is used to indicate schematically the basic functions of each network as known to one of skill in the art, and is not intended to be exhaustive. For example, 4G core 417 is shown using a single interface to 4G access 416, although in some cases 4G access can be supported using dual connectivity or via a non-standalone deployment architecture.

Noteworthy is that the RANs 401, 402, 403, 404 and 436 rely on specialized core networks 405, 406, 407, 408, 409, 437 but share essential management databases 430, 431, 432, 433, 434, 435, 438. More specifically, for the 2G GERAN, a BSC 401c is required for Abis compatibility with BTS 401b, while for the 3G UTRAN, an RNC 402c is required for Iub compatibility and an FGW 402d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

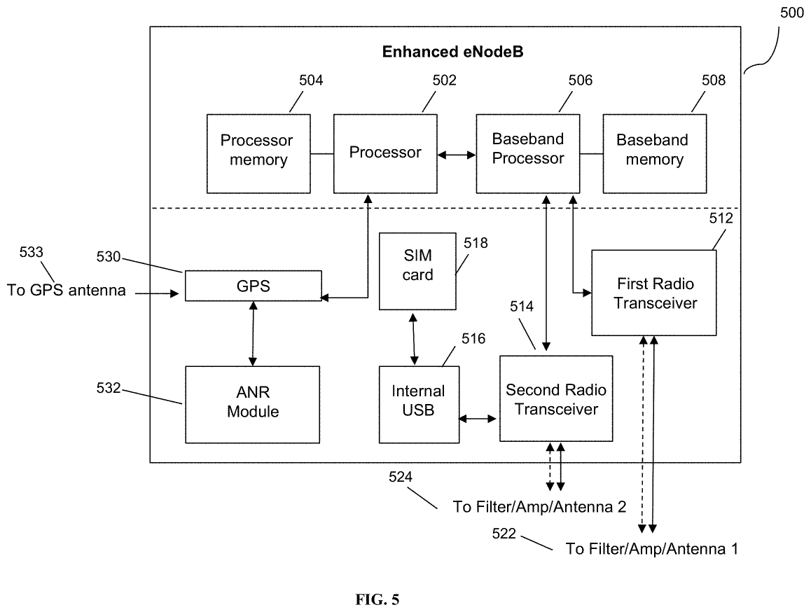

FIG. 5 is an enhanced eNodeB for performing the methods described herein, in accordance with some embodiments. Mesh network node 500 includes processor 502, processor memory 504 in communication with the processor, baseband processor 506, and baseband processor memory 508 in communication with the baseband processor. Mesh network node 500 also includes first radio transceiver 512 and second radio transceiver 514, internal universal serial bus (USB) port 516, and subscriber information module card (SIM card) 518 coupled to USB port 516. In some embodiments, the second radio transceiver 514 itself is coupled to USB port 516, and communications from the baseband processor is passed through USB port 516. The second radio transceiver is used for wirelessly backhauling eNodeB 500.

Processor 502 and baseband processor 506 are in communication with one another. Processor 502 performs routing functions, and determines if/when a switch in network configuration is needed. Baseband processor 506 generates and receives radio signals for both radio transceivers 512 and 514, based on instructions from processor 502. In some embodiments, processors 502 and 506 are on the same physical logic board. In other embodiments, they are on separate logic boards.

Processor 502 identifies the appropriate network configuration, and performs routing of packets from one network interface to another accordingly. Processor 502 uses memory 504, in particular to store a routing table to be used for routing packets. Baseband processor 506 performs operations to generate the radio frequency signals for transmission or retransmission by both transceivers 510 and 512. Baseband processor 506 also performs operations to decode signals received by transceivers 512 and 514. Baseband processor 506 uses memory 508 to perform these tasks.

The first radio transceiver 512 is a radio transceiver capable of providing LTE eNodeB functionality, and is capable of higher power and multi-channel OFDMA. The second radio transceiver 514 is a radio transceiver capable of providing LTE UE functionality. Both transceivers 512 and 514 are capable of receiving and transmitting on one or more LTE bands. In some embodiments, either or both of transceivers 512 and 514 are capable of providing both LTE eNodeB and LTE UE functionality. Transceiver 512 is coupled to processor 502 via a Peripheral Component Interconnect-Express (PCI-E) bus, and/or via a daughtercard. As transceiver 514 is for providing LTE UE functionality, in effect emulating a user equipment, it is also connected via the same or different PCI-E bus, or by a USB bus, and is also be coupled to SIM card 518. First transceiver 512 is coupled to first radio frequency (RF) chain (filter, amplifier, antenna) 522, and second transceiver 514 is coupled to second RF chain (filter, amplifier, antenna) 524.

SIM card 518 provides information required for authenticating the simulated UE to the evolved packet core (EPC). When no access to an operator EPC is available, a local EPC is used, or another local EPC on the network is used. This information is stored within the SIM card, and includes one or more of an international mobile equipment identity (IMEI), international mobile subscriber identity (IMSI), or other parameter needed to identify a UE. Special parameters are stored in the SIM card or provided by the processor during processing to identify to a target eNodeB that device 500 is not an ordinary UE but instead is a special UE for providing backhaul to device 500.

Wired backhaul or wireless backhaul is used. Wired backhaul is an Ethernet-based backhaul (including Gigabit Ethernet), or a fiber-optic backhaul connection, or a cable-based backhaul connection, in some embodiments. Additionally, wireless backhaul is provided in addition to wireless transceivers 512 and 514, which is Wi-Fi 802.11a/b/g/n/ac/ad/ah, Bluetooth, ZigBee, microwave (including line-of-sight microwave), or another wireless backhaul connection. Any of the wired and wireless connections described herein is used flexibly for either access (providing a network connection to UEs) or backhaul (providing a mesh link or providing a link to a gateway or core network), according to identified network conditions and needs, and is under the control of processor 502 for reconfiguration.

A GPS module 530 is also be included, and is in communication with a GPS antenna 532 for providing GPS coordinates, as described herein. When mounted in a vehicle, the GPS antenna is located on the exterior of the vehicle pointing upward, for receiving signals from overhead without being blocked by the bulk of the vehicle or the skin of the vehicle. Automatic neighbor relations (ANR) module 532 is present and is run on processor 502 or on another processor, or is located within another device, according to the methods and procedures described herein.

Other elements and/or modules are also included, such as a home eNodeB, a local gateway (LGW), a self-organizing network (SON) module, or another module. Additional radio amplifiers, radio transceivers and/or wired network connections are included.

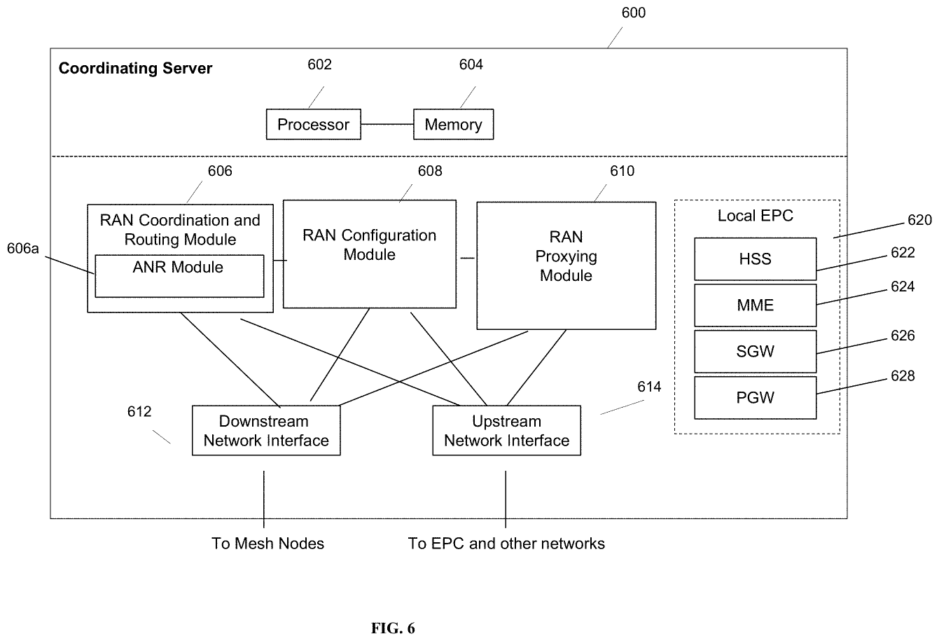

FIG. 6 is a coordinating server for providing services and performing methods as described herein, in accordance with some embodiments. Coordinating server 600 includes processor 602 and memory 604, which are configured to provide the functions described herein. Also present are radio access network coordination/routing (RAN Coordination and routing) module 606, including ANR module 606a, RAN configuration module 608, and RAN proxying module 610. The ANR module 606a performs the ANR tracking, PCI disambiguation, ECGI requesting, and GPS coalescing and tracking as described herein, in coordination with RAN coordination module 606 (e.g., for requesting ECGIs, etc.). In some embodiments, coordinating server 600 coordinates multiple RANs using coordination module 606. In some embodiments, coordination server also provides proxying, routing virtualization and RAN virtualization, via modules 610 and 608. In some embodiments, a downstream network interface 612 is provided for interfacing with the RANs, which is a radio interface (e.g., LTE), and an upstream network interface 614 is provided for interfacing with the core network, which is either a radio interface (e.g., LTE) or a wired interface (e.g., Ethernet).

Coordinator 600 includes local evolved packet core (EPC) module 620, for authenticating users, storing and caching priority profile information, and performing other EPC-dependent functions when no backhaul link is available. Local EPC 620 includes local HSS 622, local MME 624, local SGW 626, and local PGW 628, as well as other modules. Local EPC 620 incorporates these modules as software modules, processes, or containers. Local EPC 620 alternatively incorporates these modules as a small number of monolithic software processes. Modules 606, 608, 610 and local EPC 620 each run on processor 602 or on another processor, or is located within another device.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof, including 5G, which supports VoLTE.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, refers to RSSI, RSFP, or any other signal strength indication or parameter.

In some embodiments, the software needed for implementing the methods and procedures described herein are implemented in a high level procedural or an object-oriented language such as C, C++, C#, Python, Java, or Perl. The software is in assembly language if desired. Packet processing implemented in a network device can include any processing determined by the context. For example, packet processing involves high-level data link control (HDLC) framing, header compression, and/or encryption. In some embodiments, software that, when executed, causes a device to perform the methods described herein are stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein are base stations compatible with a Long Term Evolution (LTE) radio transmission protocol or air interface. The LTE-compatible base stations are eNodeBs. In addition to supporting the LTE protocol, the base stations also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein support Wi-Fi air interfaces, which also include one or more of IEEE 802.11a/b/g/n/ac/af/p/h. In some embodiments, the base stations described herein support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein are stored on a computer-readable medium such as a computer memory storage device, a hard disk, a flash drive, an optical disc, or the like. As will be understood by those skilled in the art, the present invention is embodied in other specific forms without departing from the spirit or essential characteristics thereof. For example, wireless network topology can also apply to wired networks, optical networks, and the like. The methods apply to LTE-compatible networks, to UMTS-compatible networks, to 5G networks, or to networks for additional protocols that utilize radio frequency data transmission. Various components in the devices described herein are added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure are made without departing from the spirit and scope of the disclosure, which is limited only by the claims which follow. Various components in the devices described herein are added, removed, or substituted with those having the same or similar functionality. Various steps as described in the figures and specification are added or removed from the processes described herein, and the steps described are performed in an alternative order, consistent with the spirit of the invention. Features of one embodiment are used in another embodiment. Other embodiments are within the following claims.

1. A method of providing Voice over Long-Term Evolution (VoLTE) Packet Data Conversion Protocol (PDCP) protection, comprising:
connecting a User Equipment (UE) Radio Resource Control (RRC);
providing a VoLTE call;
determining, when the VoLTE call has ended, if unused bearer values for a current key are used; and
when unused bearer values for a current key are unused, allocating new bearer value for a next VoLTE call.

2. The method of claim 1 further comprising when unused bearer values for a current key are used, performing key generation.

3. The method of claim 2 further comprising resetting a used bearer list.

4. The method of claim 2 wherein performing key generation comprises performing horizontal key generation with an eNodeB.

5. The method of claim 2 wherein performing key generation comprises performing vertical key generation with a core network.

6. The method of claim 1 further comprising reinitializing a COUNT keystream component to zero when a bearer is allocated.

7. A system providing Voice over Long-Term Evolution (VoLTE) Packet Data Conversion Protocol (PDCP) protection, comprising:
an eNodeB including Radio Resource Control (RRC);
wherein the eNodeB receives a VoLTE call and determines, when the VoLTE call has ended, if unused bearer values for a current key are used; and
wherein when unused bearer values for a current key are unused, allocates a new bearer value for a next VoLTE call.

8. The system of claim 7 wherein when unused bearer values for a current key are used, the eNodeB performs key generation.

9. The system of claim 8 further comprising the eNodeB resetting a used bearer list.

10. The system of claim 8 wherein performing key generation comprises performing horizontal key generation with the eNodeB.

11. The system of claim 8 wherein performing key generation comprises performing vertical key generation with a core network.

12. The system of claim 1 further comprising reinitializing a COUNT keystream component to zero when a bearer is allocated.

13. A non-transitory computer-readable medium containing instructions for providing Voice over Long-Term Evolution (VoLTE) Packet Data Conversion Protocol (PDCP) protection, which, when executed, cause a system to perform steps comprising:
connecting a User Equipment (UE) Radio Resource Control (RRC);
providing a VoLTE call;
determining, when the VoLTE call has ended, if unused bearer values for a current key are used; and
when unused bearer values for a current key are unused, allocating new bearer value for a next VoLTE call.

14. The computer-readable medium of claim 13 further comprising instructions for when unused bearer values for a current key are used, performing key generation.

15. The computer-readable medium of claim 14 further comprising instructions for resetting a used bearer list.

16. The computer-readable medium of claim 14 wherein performing instructions for key generation comprises performing horizontal key generation with an eNodeB.

17. The computer-readable medium of claim 14 wherein instructions for performing key generation comprises instructions for performing vertical key generation with a core network.

18. The computer-readable medium of claim 13 further comprising instructions for reinitializing a COUNT keystream component to zero when a bearer is allocated.
